(19) United States
(12) Patent Application Publication
(10) Pub. No.: US 2010/0049749 A1
(43) Pub. Date: Feb. 25, 2010

(54) System of synchronizing data between storage devices and method thereof

(75) Inventors: Chaucer Chiu, Taipei (TW); Jenny Xu, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/230,056

(22) Filed: Aug. 22, 2008

(51) Int. Cl. G06F 17/30

(52) U.S. Cl. 707/201; 707/E17.032

(57) ABSTRACT

A system of synchronizing data in different storage devices and the method thereof are provided to remove the inconvenience in synchronizing data between storage devices. By detecting the process execution status, data synchronization is triggered to transmit data. The invention can achieve the goal of increasing the efficiency of data synchronization between storage devices.

### BACKGROUND OF THE INVENTION

1. Field of Invention

The invention relates to a data synchronization system and the method thereof. In particular, it pertains to a system of synchronizing data between storage devices by detecting the process execution status and the method thereof.

2. Related Art

With the rapid development in semiconductor technology and consumer electronic products in recent years, storage devices have volumes, capacities, prices and functions that can be widely accepted by the public. In particular, the plug-and-play storage devices, such as the USB disks, are the most popular consumer electronics among all.

However, as there are more applications for the storage device, people have higher demands in the functions thereof, particularly in the ability of data synchronization. Convenient data synchronization for data sharing is impossible among conventional storage devices. The only way to achieve the above-mentioned goal is to first connect a storage device to a computer and then synchronize data therein with the computer. Afterwards, another storage device is connected to the computer for data synchronization. Since it is impossible to directly synchronize between two storage devices, the task of data synchronization between storage devices becomes tedious.

In order to solve this problem, some companies provide data synchronization programs installed on a computer-executable platform for the user to synchronize data in storage devices connected to the computer-executable platform. Nevertheless, this method of data synchronization requires the installation of data synchronization program on a computer-executable platform. Moreover, the cross-platform support is another problem. Therefore, this method of installing a data synchronization program on a computer-executable platform for data synchronization still cannot completely remove the inconveniences.

In summary, the prior art long has the inconvenience in synchronizing data between storage devices. It is therefore imperative to provide a solution.

### SUMMARY OF THE INVENTION

In view of the foregoing, the invention discloses a system of synchronizing data between storage devices and the method thereof.

The disclosed system of synchronizing data between storage devices running on a computer-executable platform includes: a detection module, a capture module, an inquiry module, and a data synchronization module. The detection module detects an execution status according to a set of detection conditions. When the execution status is repeated running, the capture module captures and records the connection status of connection ports in connection parameter according to determination conditions. The inquiry module inquires data configurations of the corresponding storage devices according to the connection parameter. The data synchronization module performs data transmissions between the connection ports having the connection parameter according to the data configuration and synchronization processing condition.

The disclosed method of synchronizing data between storage devices running on a computer-executable platform includes the steps of: detecting an execution status according to detection conditions; when the execution status is repeated running, capturing and recording the connection status of connection ports in connection parameter according to determination conditions; inquiring data configurations of the corresponding storage devices according to the connection parameter; and performing data transmissions between the connection ports having the connection parameter according to the data configuration and synchronization processing condition.

The disclosed system and method have been described above. Its primary difference from the prior art is in that the data synchronization is triggered through the detection of the process execution status for data transmissions.

Using the disclosed technical means, the invention can increase the efficiency in synchronizing data between storage devices.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed system of synchronizing data between storage devices;

FIG. 2 is a flowchart of the disclosed method of synchronizing data between storage devices; and

FIGS. 3 to 5 are schematic views showing the operation of data synchronization according to the invention.

### DETAILED DESCRIPTION OF THE INVENTION

The present invention will be apparent from the following detailed description, which proceeds with reference to the accompanying drawings, wherein the same references relate to the same elements.

Before describing the disclosed system and method of synchronizing data between storage devices, we describe the background of the invention. The invention pertains to a mechanism of synchronizing data between storage devices that runs on a computer-executable platform. However, the disclosed storage device can automatically execute the program without installing it on a computer-executable platform. (For example, the U3 platform technology has such features of auto execution, carrying software programs, password protection, personal environment and data.) During the execution process, the invention monitors the process execution status running on a computer-executable platform to determine whether to perform data synchronization. Since the part of loading programs from a storage device to a computer-executable platform and automatically running it is well known in the prior art, it is not repeated herein.

The terms used in this specification are defined as follows. The detection conditions referred herein are program names and process ID (PID). They are used to determine whether a program has multiple copies running. When a computer-executable platform executes a program, it stores its name and assigns a unique PID to it. Even if the same program has several copies running concurrently, their PID's are not the same. That is, the computer-executable platform assigns distinct PID's to the same running program in order to distinguish different processes. To obtain the PID's assigned by the computer-executable platform, one can run the kernel API of the operating system (OS), such as find_task_by_pid. When different PID's with the same program name are detected in the computer-executable platform, it means that the same program is running more than once. (For example, suppose there are three different PID's with the same program name. It means that the same program is repeatedly running for three copies.) Therefore, it is possible to determine whether a program has multiple jobs at the same time from the program name and PID's. The process execution status refers to the execution status of the program, including running (e.g., having the name and the corresponding PID for the disclosed program), repeated running (e.g., having multiple name and corresponding distinct PID's for the disclosed program), and not running (e.g., no name for the disclosed program). These statuses can be determined according to the above-mentioned detection conditions. The determination condition can be a device ID. The device ID is a unique ID burned into the storage device (e.g., a USB disk) by the manufacturer, including a vendor ID and a product ID. It is mainly used for identifying the storage device. (For example, when the determination condition is the device ID, the invention determines whether the storage device supports synchronization from the vendor ID and the product ID.) The connection port is a data transmission port with the plug-and-play (PnP) function, such as a universal serial bus (USB). The connection parameter store the connection port and connection status of another storage device also connected to the computer-executable platform. The data configuration is the data storage location (e.g., storage folder of self-built word bank file). The data configuration can be obtained by inquiring.

Besides, the synchronization processing condition is used to set the method of data synchronization (e.g., copying data from one storage device to another to achieve data synchronization). The synchronization processing condition can be a default one or one that set by the user. The setting detail will be described later.

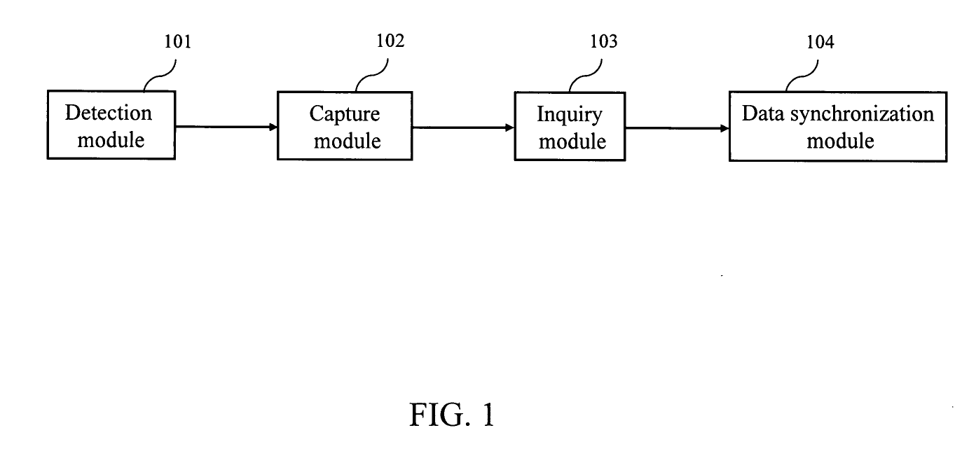

Before explaining the embodiment of the invention, the system of synchronizing data between storage devices and the method thereof are first described with reference to the companying figures. Please refer to FIG. 1, which is a system block diagram of the disclosed system of synchronizing data between storage devices. The system includes: a detection module 101, a capture module 102, an inquiry module 103, and a data synchronization module 104. The detection module 101 is used to detect an execution status according to the detection conditions that have been described before.

When the execution status is repeated running, the capture module 102 captures and records the connection statuses (“connected” or “disconnected”) of connection ports according to the determination conditions, such as the device ID. The results are recorded in the connection parameter (e.g., recording connection status and the corresponding code of a connection port). The connection port referred herein is a data transmission port with the PnP function. The device ID, as mentioned before, is a set of ID for identifying the storage device, including the vendor ID and product ID thereof. Therefore, the device ID can be used to determine whether data synchronization is possible among various storage devices. (For example, the storage devices made by the same manufacturer or in the same series can be designed to support data synchronization among themselves.) Moreover, the connection ports of the storage devices that support data synchronization are recorded in the connection parameter.

The inquiry module 103 inquires the data configuration of the corresponding storage device according to the connection parameter. The data configuration is the data storage location (e.g., storage folder of self-built word bank file). The data configuration can be obtained by inquiring (e.g., searching the file allocation table or the index file).

The data synchronization module 104 performs data transmissions with the connection ports recorded in the connection parameter (e.g., connection ports used by storage devices that support synchronization) according to the data configuration and synchronization processing conditions (e.g., default or user-defined data synchronization conditions).

Besides, the disclosed system of synchronizing data between storage devices further includes a data synchronization window for the user to operate data synchronization and set synchronization processing conditions. The method of setting synchronization processing conditions via the data synchronization window will be described in detail using an embodiment later.

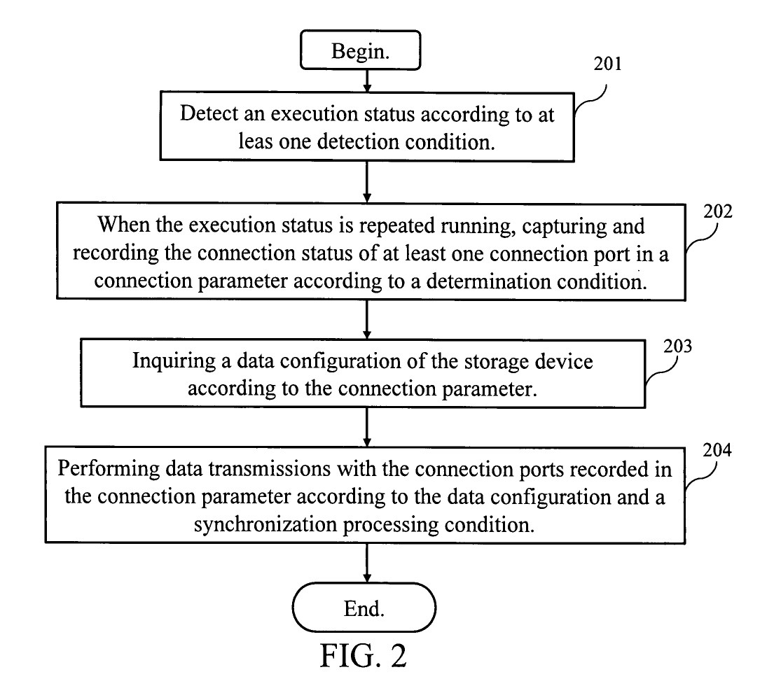

Please refer to FIG. 2, which is a flowchart for the disclosed method of synchronizing data between storage devices. The method includes the following steps. Step 201 detects an execution status according to detection conditions. Step 202 capturing and recording the connection statuses of connection ports in connection parameter according to determination conditions when the execution status is repeated running. Step 203 inquiring the data configuration of storage devices according to the connection parameter. Step 204 performing data transmissions with the connection ports recorded in the connection parameter according to the data configuration and synchronization processing conditions. In particular, the method further includes the step of using a data synchronization window to perform data synchronization operations and to set the synchronization processing conditions.

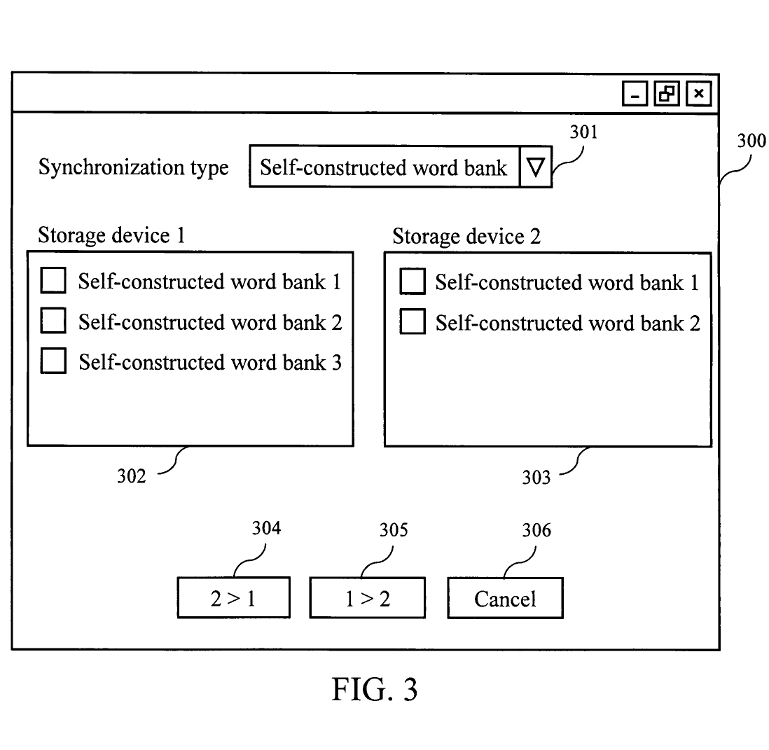

The following paragraphs use an embodiment along with FIGS. 3 to 5 to explain the invention. FIGS. 3 to 5 are schematic views of data synchronization according to the invention. When a storage device is connected to a computer-executable platform (e.g., a personal computer), the computer-executable platform automatically executes the disclosed program (e.g., a translation program) stored in the storage device. The technique of automatic execution belongs to the prior art and is not addressed herein. In this case, the detection module 101 detects the execution status according to the detection conditions (e.g., program name and PID's). (For example, the disclosed program calls the OS kernel API of the computer-executable platform, such as find_task_by_name and find_task_by_pid, to detect the program name and PID's. Once different PID's are detected for processes of the same program name, the execution status is determined as “repeated running.”)

When the execution status is repeated running, the capture module 102 captures and records the connection statuses (“connected” or “disconnected”) of the connection ports according to the determination conditions (e.g., device ID). For example, when a storage device is inserted into a connection port of the computer-executable platform (the code for the connection port being “port1”), the detection module 101 detects whether there are any processes having the same program name but different PID's running on the computer-executable platform. If the execution status is repeated running, it means that there is another storage device connected to and running on the computer-executable platform. In this case, the storage device captures according to the device ID the connection status of another connection port (i.e., the connection port used by the other storage device with the port code “port2”) into the connection parameter (e.g., connection port code being “port2” and connection status being “connected”). If the execution status detected by the detection module 101 is not repeated running, then the system performs no capture and recording.

As mentioned before, the storage device captures the connection status of another connection port according to the device ID. The capture process is as follows. The device ID of the storage device (i.e., the first device ID) and the device ID of another storage device (i.e., the second device ID) are compared. The comparison checks the vendor ID or device ID or their combination to determine whether they support data synchronization. When compatible device ID's are found, it means that the computer-executable platform simultaneously connects to storage devices made by the manufacturer or even of the same model series. They can then perform data synchronization.

Afterwards, the inquiry module 103 inquires the data configuration of the corresponding storage device according to the connection parameter (e.g., inquiring the data configuration of the storage device whose connection port code is “port2”). The inquiry can be achieved by looking up the file allocation table (FAT). Afterwards, the data synchronization module 104 follows the above-mentioned data configuration and the default synchronization processing condition (e.g., receiving synchronization data transmitted from other storage devices without conditions by default) to perform data transmissions with the connections recorded in the connection parameter (e.g., the recorded connection port code being “port2”). Moreover, a data synchronization window 300 as schematically shown in FIG. 3 can be generated for the user to define the synchronization processing conditions.

As described above, when the data synchronization window 300 is generated, the user can use a synchronization type selection element 301 to select the types of data to be synchronized (e.g., self-constructed word bank). The user can use a synchronization data selection block 1 302 to learn about the data files of the selected data type (e.g., self-constructed word bank), such as data files in self-constructed word bank 1, self-constructed word bank 2, and self-constructed word bank 3. Besides, the user can also learn about the data files of the selected data type (e.g., self-constructed word bank) in another storage device from a synchronization data selection block 2 303, such as the data files in self-constructed word bank 1 and self-constructed word bank 2. Using the synchronization data selection block 1 302 and the synchronization data selection block 2 303, the user is allowed to choose the data files to be synchronized.

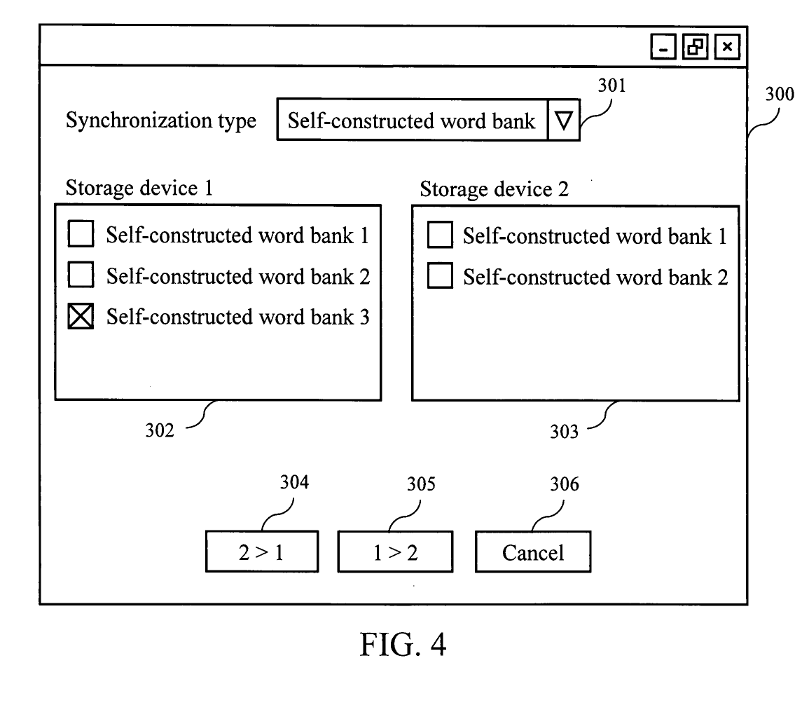

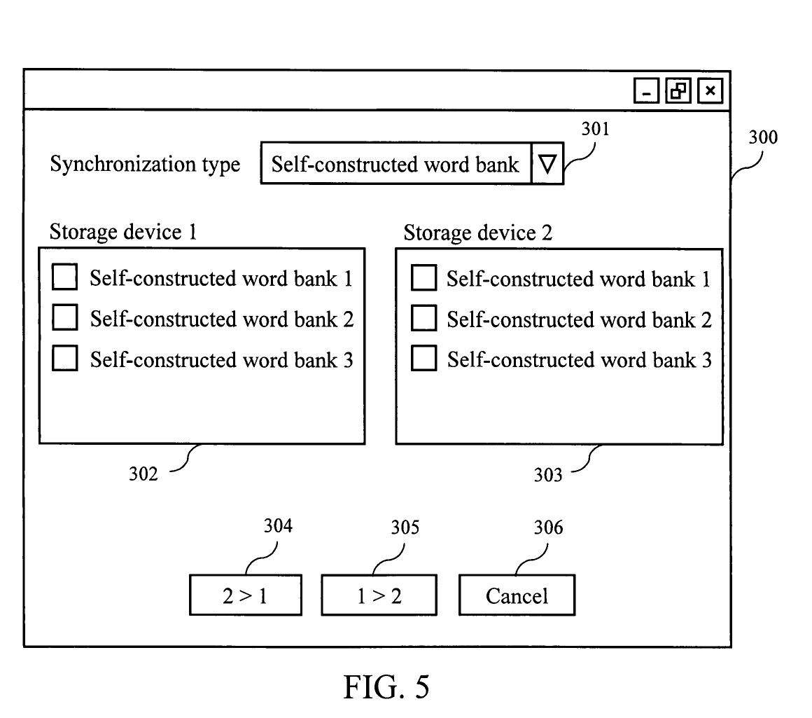

Please refer to FIG. 4. When the user select data files to be synchronized through the synchronization data selection block 1 302 (e.g., self-constructed word bank 3), a selection label is generated for the selected data file in the synchronization data selection block, as shown in the drawing. (In this example, the checkbox is checked.) Afterwards, the user uses a synchronization confirmation element 1 304 to generate the synchronization processing conditions according to the selections of the synchronization data selection block 1 302. Data transmissions are then performed in the connection ports recorded in the connection parameter (e.g., connection port with the code “port2”). Finally, after data transmissions are done, as shown in FIG. 5, synchronized data files (e.g., self-constructed word bank 3) are displayed in the synchronization data selection block 2 303. This completes the data synchronization between storage devices according to the invention.

Besides, the user can perform operations opposite to the above description through a synchronization confirmation element 2 305. Its description is not further described herein. When the user does not want to perform data synchronization, he or she can close the data synchronization window through a cancellation element 306. It should be emphasized that the elements in the data synchronization window 300 are not restricted to the example given herein.

In summary, the difference between the invention and the prior art is in the detection of a program execution status. The status is used to trigger data synchronization and data transmissions. Using the disclosed technique, data can be conveniently synchronized between storage devices. Therefore, the invention can achieve the goal of increasing the efficiency of synchronizing data between storage devices.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system of synchronizing data between storage devices running on a computer-executable platform, comprising:
a detection module, which detects an execution status according to at least one detection condition;
a capture module, which captures and records the connection status of at least one connection port in a connection parameter according to a determination condition when the execution status is repeated running;
an inquiry module, which inquires a data configuration of the storage device according to the connection parameter; and
a data synchronization module, which performs data transmissions with the connection ports recorded in the connection parameter according to the data configuration and a synchronization processing condition.

2. The system of synchronizing data between storage devices as in claim 1, wherein the detection conditions include a program name and a process ID (PID).

3. The system of synchronizing data between storage devices as in claim 1, wherein the execution statuses further include running and not running.

4. The system of synchronizing data between storage devices as in claim 1, wherein the determination condition is a device ID.

5. The system of synchronizing data between storage devices as in claim 1, wherein the connections are data transmission ports with the plug-and-play (PnP) function.

6. The system of synchronizing data between storage devices as in claim 4, wherein the PID includes the vendor ID and the product ID of the storage device.

7. The system of synchronizing data between storage devices as in claim 1, wherein the data configuration is the data storage locations of the storage device.

8. The system of synchronizing data between storage devices as in claim 1 further comprising a data synchronization window for operations of data synchronization and setting the synchronization processing condition.

9. A method of synchronizing data between storage devices running on a computer-executable platform, comprising the steps of:
detecting an execution status according to at least one detection condition;
capturing and recording the connection status of at least one connection port in a connection parameter according to a determination condition when the execution status is repeated running;
inquiring a data configuration of the storage device according to the connection parameter; and
performing data transmissions with the connection ports recorded in the connection parameter according to the data configuration and a synchronization processing condition.

10. The method of synchronizing data between storage devices as in claim 9, wherein the detection conditions include a program name and a process ID (PID).

11. The method of synchronizing data between storage devices as in claim 9, wherein the execution statuses further include running and not running.

12. The method of synchronizing data between storage devices as in claim 9, wherein the determination condition is a device ID.

13. The method of synchronizing data between storage devices as in claim 9, wherein the connections are data transmission ports with the plug-and-play (PnP) function.

14. The method of synchronizing data between storage devices as in claim 12, wherein the PID includes the vendor ID and the product ID of the storage device.

15. The method of synchronizing data between storage devices as in claim 9, wherein the data configuration is the data storage locations of the storage device.

16. The method of synchronizing data between storage devices as in claim 9 further comprising the step of using a data synchronization window to perform operations of data synchronization and to set the synchronization processing condition.
